(19) United States
(12) Patent Application Publication
(10) Pub. No.: US 2006/0131841 A1
(43) Pub. Date: Jun. 22, 2006

(54) Frame structure for baby stroller with detachable infant carrier

(76) Inventor: Mien Chen Huang, Tainan (TW)

Correspondence Address: PRO-TECTOR INTERNATIONAL SERVICES, 20775 NORADA CT., SARATOGA, CA, 95070, US

(21) Appl. No.: 11/015,878

(22) Filed: Dec. 16, 2004

(51) Int. Cl. B62B 1/00

(52) U.S. Cl. 280/647

(57) ABSTRACT

Disclosed is a frame structure for baby stroller, which includes two front-leg tubes, two rear-leg tubes, two handlebars pivotally coupled to the front-leg tubes, two bottom tubes respectively pivotally coupled between the front-leg tubes and the rear-leg tubes; two front extension bars respectively pivoted to the two front-leg tubes, each front extension bar having a front rod member, a rear rod member pivoted to one front-leg tube, and a joint coupled between the front rod member and the rear rod member for allowing the front rod member to be turned relative to the rear rod member and locked at the desired angle, and two quick-release locks respectively applied on the front rod members of the front extension bars to hold a foldable front cross bar between the front rod members of the front extension bars for allowing movement of the foldable front cross bar along the front extension bars to fit different infant carriers when unlocked the quick-release locks.

### BACKGROUND OF THE INVENTION

1. Field of the Invention

The present invention relates to children's gear and more particularly, to a frame structure for baby stroller with detachable infant carrier suitable for use in a motor vehicle to carry a baby.

2. Description of the Related Art

An infant carrier is a device for carrying an infant inside a motor vehicle. A baby stroller is a light chair-like baby carriage. These two devices are designed for different purposes. For ease of use, combined stroller and infant carrier systems have been disclosed and have appeared on the market (for example, U.S. Pat. No. 6,398,233, entitled “Foldable stroller with separable infant carrier”).

Other strollers capable of holding an infant carrier are seen in U.S. Pat. No. 6,446,990 (entitled “Transport vehicle for an infant of low age”); U.S. Pat. No. 6,302,412 (entitled “Folding stroller”); D463,760 (entitled “The ornamental design for a stroller”). These stroller designs cannot be used to carry a child of low age before loading of an infant carrier.

### SUMMARY OF THE INVENTION

The present invention has been accomplished under the circumstances in view. It is one object of the present invention to provide a frame structure for baby stroller with detachable infant carrier, which fits different infant carriers from different manufactures. It is another object of the present invention to provide a frame structure for baby stroller with detachable infant carrier, which is highly folding collapsible. To achieve these and other objects of the present invention, the frame structure for baby stroller comprises two front-leg tubes, the front-leg tubes each having a first connector and a second connector; two rear-leg tubes; two handlebars respectively pivotally connected to the first connectors of the front-leg tubes; two bottom tubes respectively pivotally coupled between the second connectors of the front-leg tubes and the rear-leg tubes; wherein two front extension bars are respectively pivoted to the second connectors of the two front-leg tubes, each front extension bar comprising a front rod member, a rear rod member pivoted to the second connector of one front-leg tube, and a joint coupled between the front rod member and the rear rod member for allowing the front rod member to be turned relative to the rear rod member and locked at the desired angle; two quick-release locks are respectively applied on the front rod members of the front extension bars to hold a foldable front cross bar between the front rod members of the front extension bars for allowing movement of the foldable front cross bar along the front extension bars when unlocked the quick-release locks.

### BRIEF DESCRIPTION OF THE DRAWINGS

FIG. 1 is an elevational view of a frame structure for baby stroller with detachable infant carrier according to the present invention.

FIG. 2 is an exploded view of FIG. 1.

FIG. 3 is an exploded view in an enlarged scale of a part of the present invention, showing the structure of the joint.

FIG. 4 is a schematic sectional view showing the operation of the joint of FIG. 3.

FIG. 5 is schematic side view showing the operation of the joint of FIG. 3.

FIG. 6 is an elevational view of an alternate form of the frame structure for baby stroller with detachable infant carrier according to the present invention.

FIG. 7 is an exploded view of FIG. 6.

FIG. 8 is an enlarged view of a part of FIG. 7, showing the structure of the control device.

FIG. 9 is a schematic sectional view showing the operation of the control device according to the present invention.

FIG. 10 is an enlarged view of a part of FIG. 2 showing the structure of the quick-release lock.

FIG. 11 is a schematic sectional view showing the operation of the quick-release lock according to the present invention.

FIG. 12 is a schematic sectional drawing showing the quick-release lock unlocked, the front cross bar moved along the front extension bar according to the present invention.

FIG. 13 is a schematic elevational view showing the two quick-release locks unlocked, the front cross bar moved along the front extension bars according to the present invention.

FIG. 14 is a schematic drawing showing the installation of the infant carrier in the frame structure for baby stroller according to the present invention.

### DETAILED DESCRIPTION OF THE PREFERRED EMBODIMENT

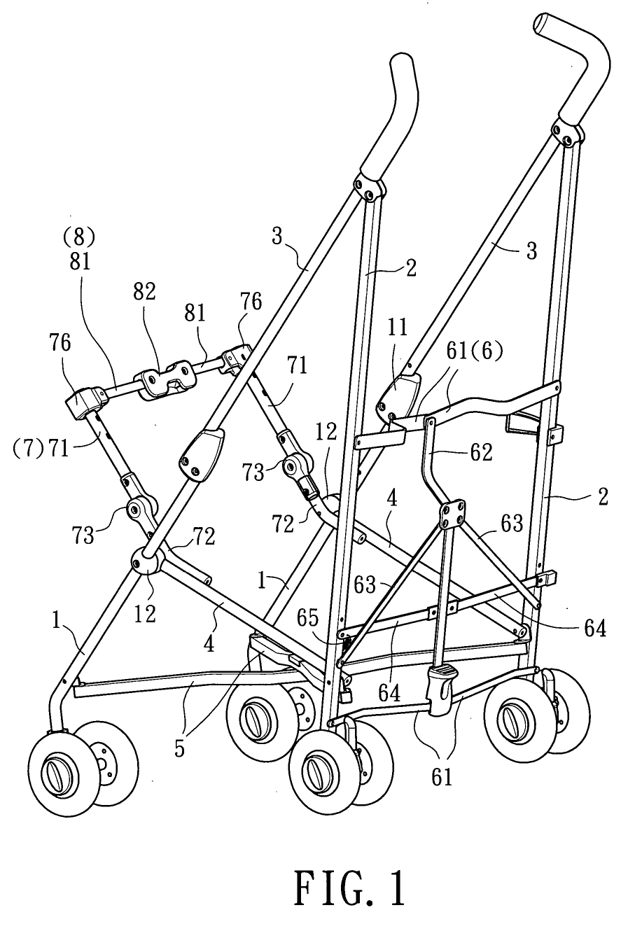

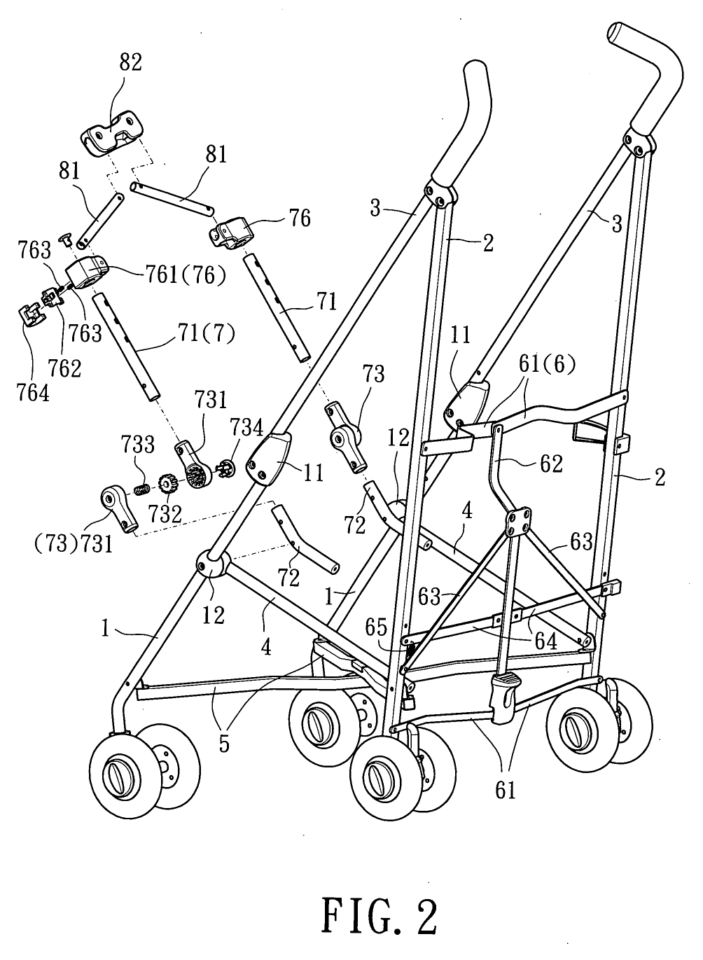

Referring to FIGS. 1 and 2, the frame structure of a baby stroller in accordance with the present invention is shown comprising two front-leg tubes 1, two rear-leg tubes 2, two handlebars 3, two bottom tubes 4 respectively pivotally coupled between the front-leg tubes 1 and the rear-leg tubes 2, two links 5 pivotally coupled together in a crossed manner and diagonally coupled between the front-leg tubes 1 and the rear-leg tubes 2, and a folding frame 6 coupled between the two rear-leg tubes 2.

The folding frame 6 comprises two pairs of links 61 respectively pivotally connected in series and respectively pivotally coupled between the rear-leg tubes 2 at different elevations, an actuating rod 62 pivotally coupled with the top and bottom ends thereof to the pivoted point between the two links of each of the two pairs of the links 61, two drag bars 63 respectively pivotally coupled between a middle part of the actuating rod 62 and the rear-leg tubes 2, two stop bars 64 pivotally connected in series between the rear-leg tubes 2 below the connection point between the drag bars 63 and the actuating rod 62 but above the connection points between the drag bars 63 and the rear-leg tubes 2, and a spring member 65 connected between one stop bar 64 and one rear-leg tube 2 to impart a downward pressure to the stop bars 64, holding the stop bars 64 in the extended, straight status. When folding the baby stroller and after having lifted the actuating rod 62, the user must lift the pivot point between the two stop bars 64 to unlock the frame structure of the baby stroller, i.e., the stop bars 64 and the spring member 65 serve as locking means to lock the frame structure of the baby stroller.

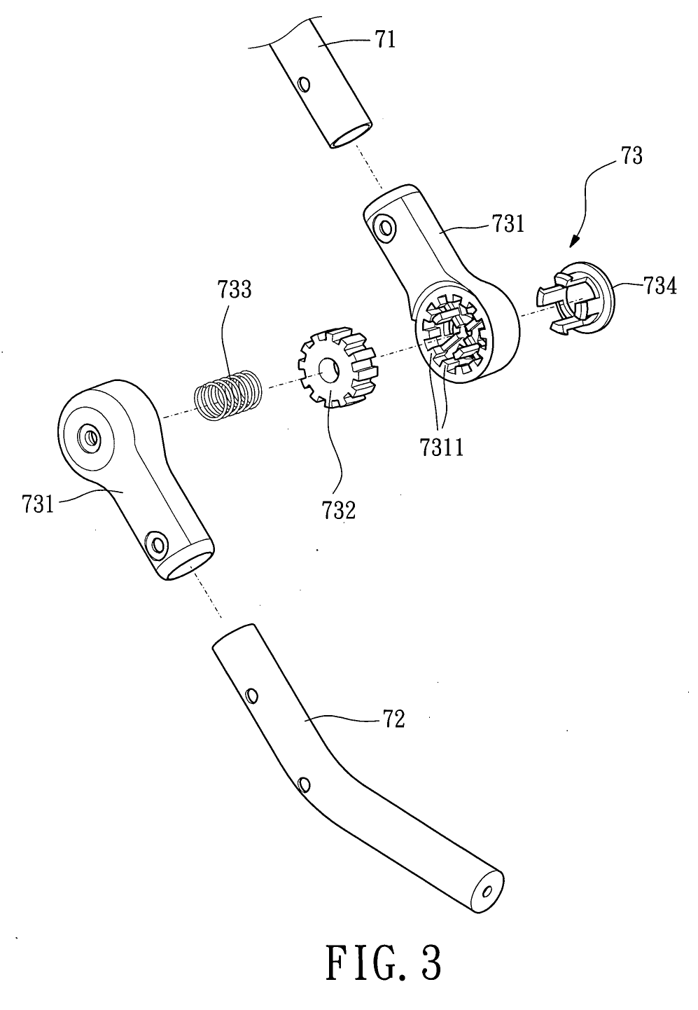

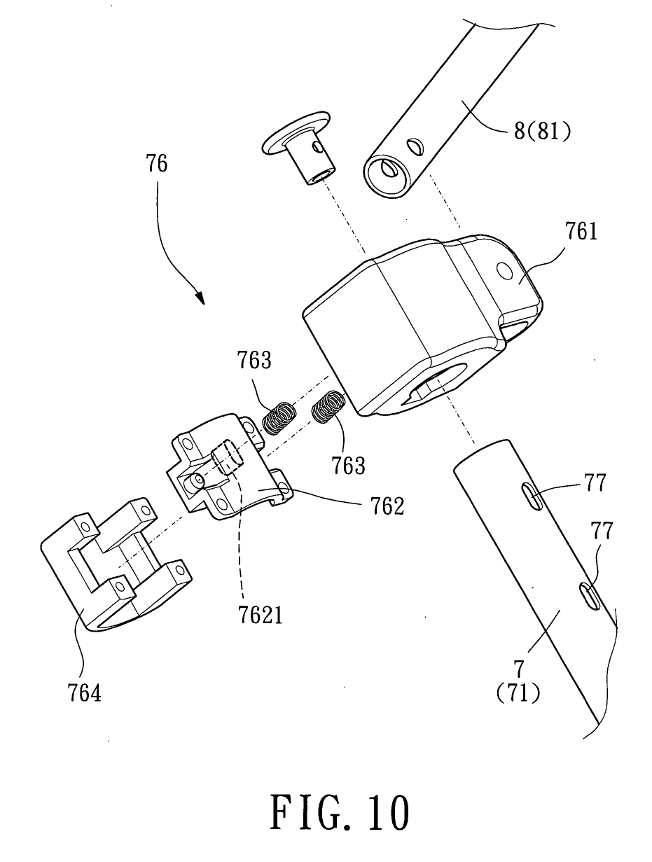

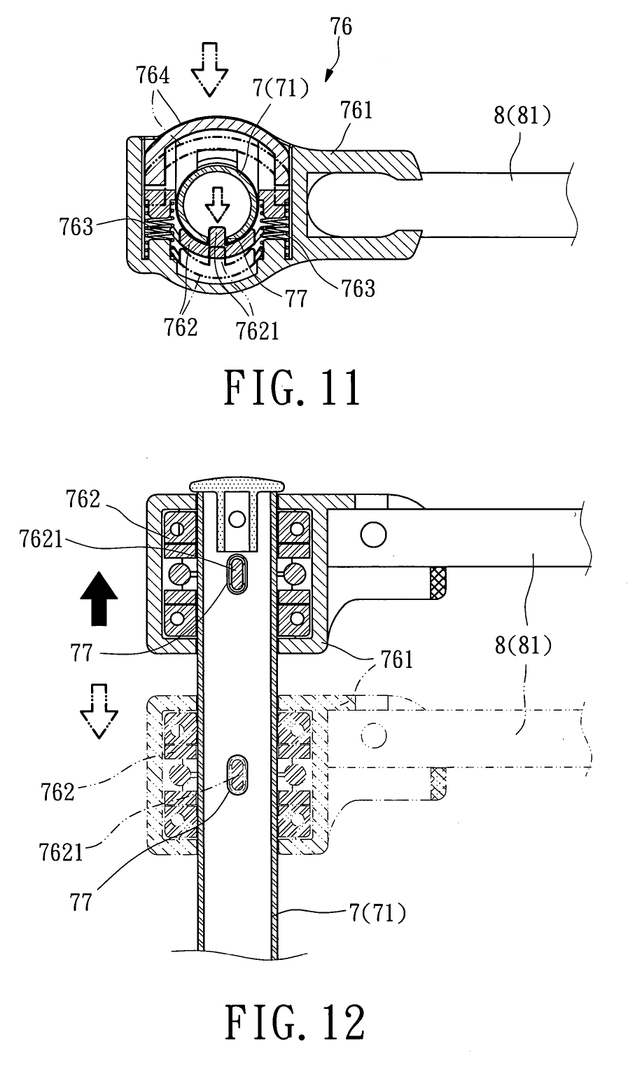

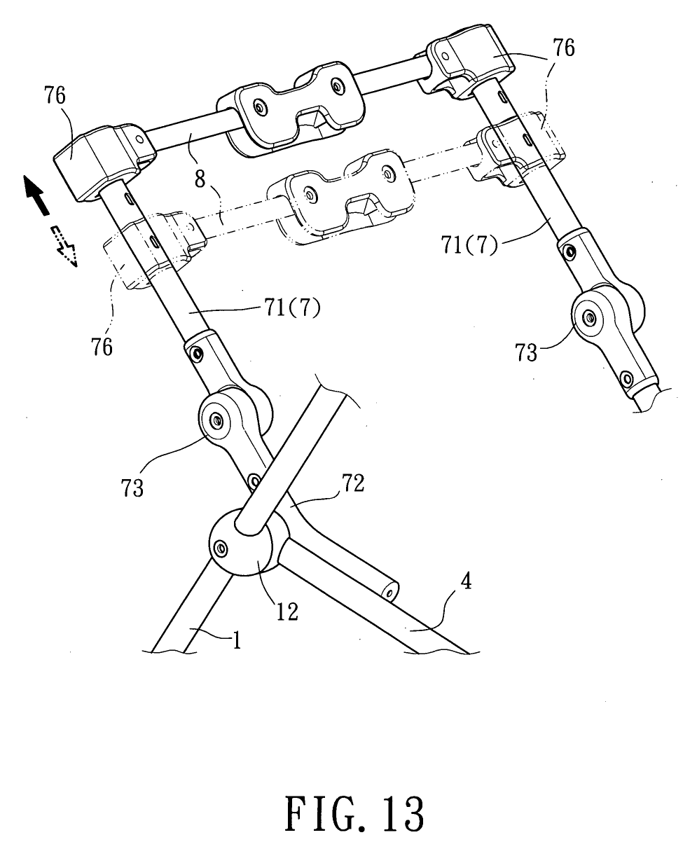

The two front-leg tubes 1 each have a first connector 11 pivotally connected to the bottom end of one handlebar 3, and a second connector 12 pivotally connected to one bottom tube 4. Two front extension bars 7 are respectively pivoted to the second connectors 12 of the two front-leg tubes 1. Each front extension bar 7 comprises a front rod member 71, a rear rod member 72 pivoted to the second connector 12 of one front-leg tube 1, and a joint 73 coupled between the front rod member 71 and the rear rod member 72 for allowing the front rod member 71 to be turned relative to the rear rod member 72 and locked at the desired angle (see FIGS. 3˜5). Further, two quick-release locks 76 are respectively applied on the front rod members 71 to hold a front cross bar 8 between the front rod members 71 of the front extension bars 7. Unlocking the quick-release locks 76 allows movement of the front cross bar 8 along the front extension bars 7 (see FIGS. 2, 7, 10˜13).

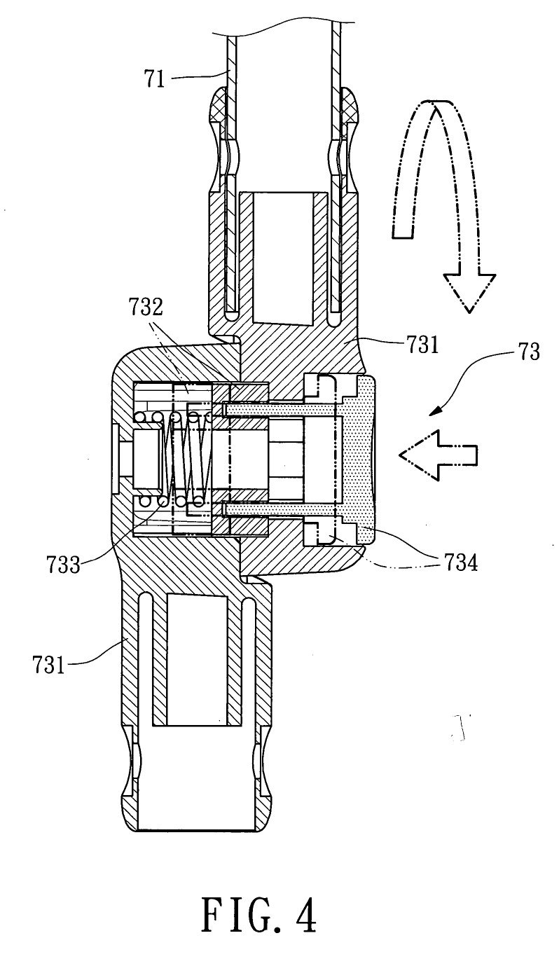

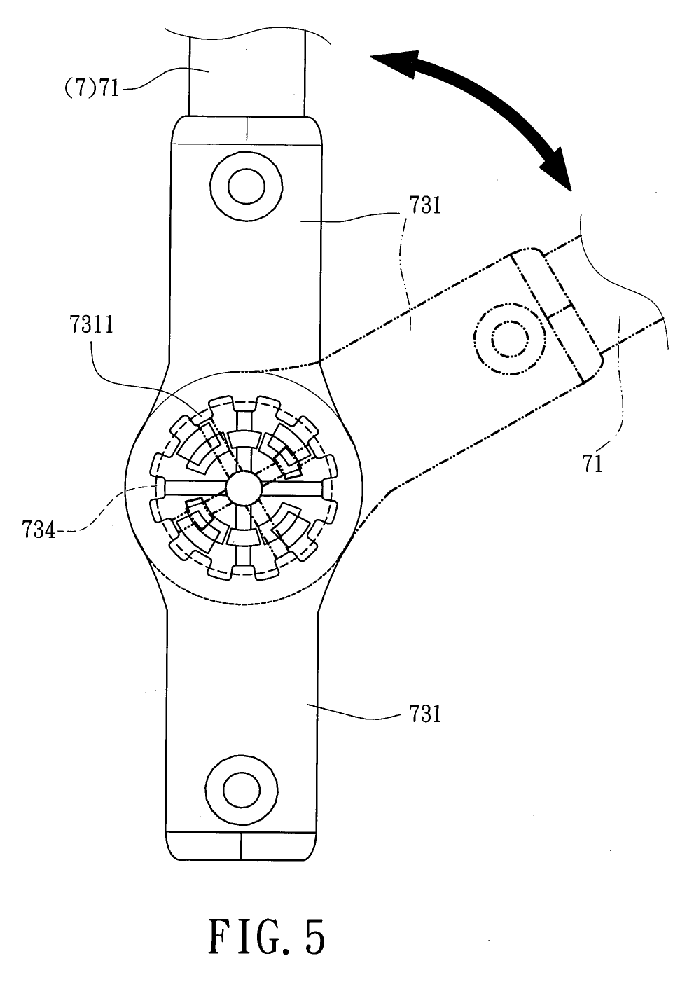

Referring to FIGS. 2˜5, the joint 73 comprises two holder members 731 respectively fastened to the front rod member 71 and the rear rod member 72, each holder member 731 having a toothed engagement portion 7311, a toothed block 712 movable between the holder members 731 and engageable with the toothed engagement portions 7311 of the holder members 731, a spring member 733 mounted in the holder member 731 at the rear rod member 72 and stopped between the respective holder member 731 and the toothed block 712 and adapted to hold the toothed block 712 in engagement with the toothed engagement portions 7311 of the two holder members 731 to lock the holder members 731 (i.e., to lock the front rod member 71 and the rear rod member 72), and a control button 734 applied on the holder member 731 at the front rod member 71 for pressing by the user to push the toothed block 712 backward against the spring member and to further disengage the toothed block 712 from the toothed engagement portion 7311 of the holder member 731 at the front rod member 71 (see FIG. 4) so that the user can turn the front rod member 71 relative to the rear rod member 72 (see FIG. 5). When released the hand from the control button 734, the spring member 733 immediately pushes the toothed block 732 into engagement with the toothed engagement portions 7311 of the two holder members 731 to lock the front rod member 71 to the rear rod member 72 at the adjusted angle.

Referring to FIGS. 2, 7, 10˜13, the quick-release lock 76 comprises a base block 761 coupled to one end of the front cross bar 8 and axially slidably sleeved onto the front rod member 71 of one front extension bar 7, a locking member 762 mounted in the base block 762, the locking member 762 having a locating pin 7621 selectively insertable in one of the longitudinally spaced locating holes 77 at the front rod member 71, two spring members 763 stopped between the base block 761 and the locking member 762 to hold the locking member 762 in the locking position where the locating pin 7621 is engaged into one of the longitudinally spaced locating holes 77 at the front rod member 71, and a control button 764 coupled to the locking member 762 for pressing by the user to disengage the locking member 762 from the longitudinally spaced locating holes 77 so that the user can move the base block 761 along the front rod member 71.

Referring to FIG. 2, the front cross bar 8 is comprised of two rod members 81 respectively coupled to the two quick-release locks 76, and a block member 82 pivotally connected between the rod members 81.

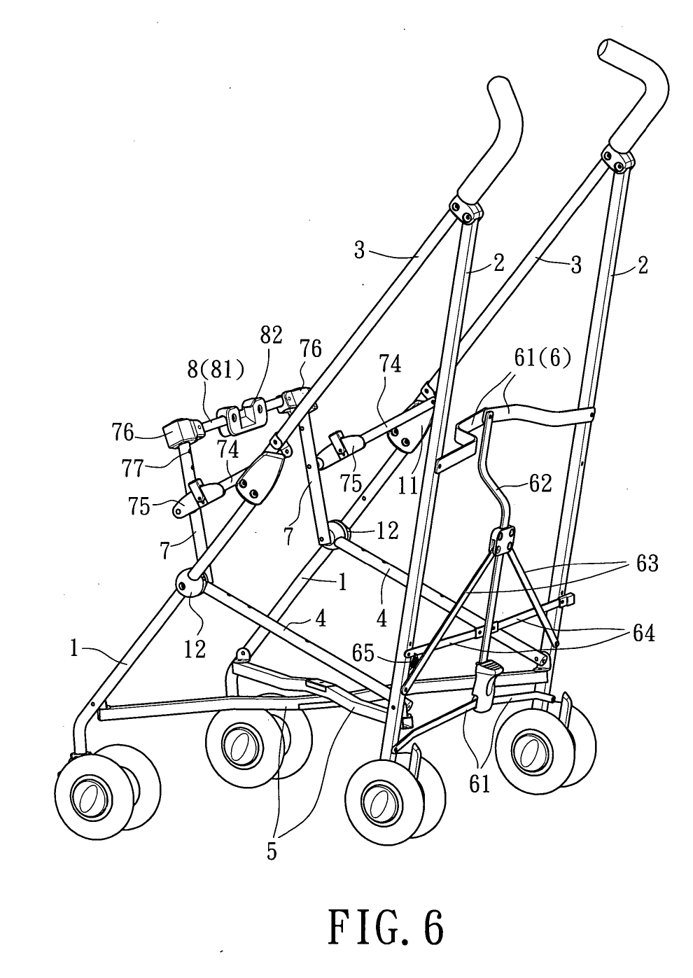

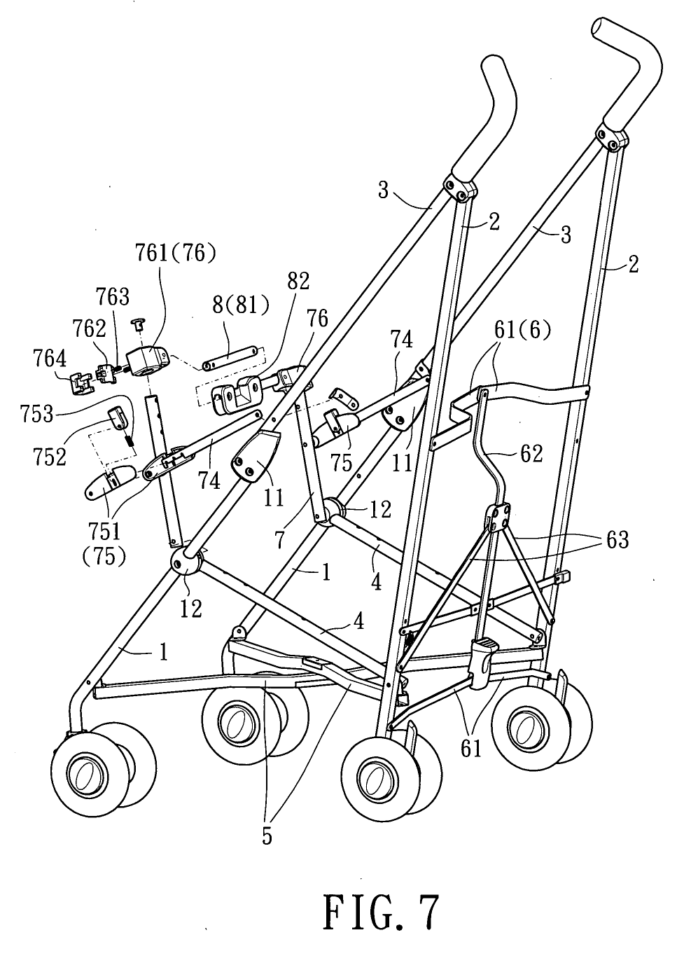

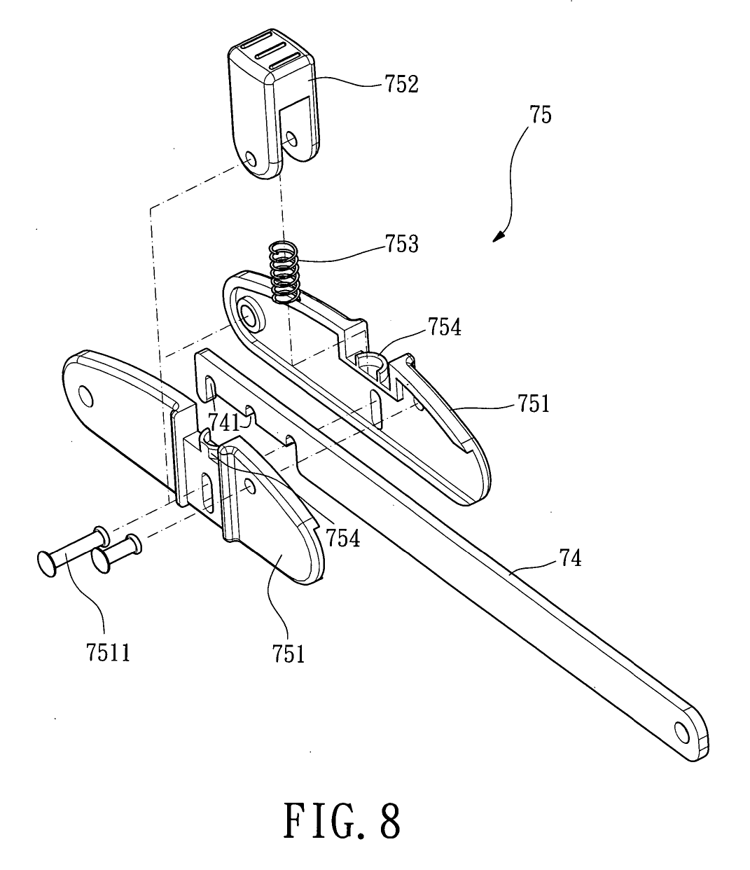

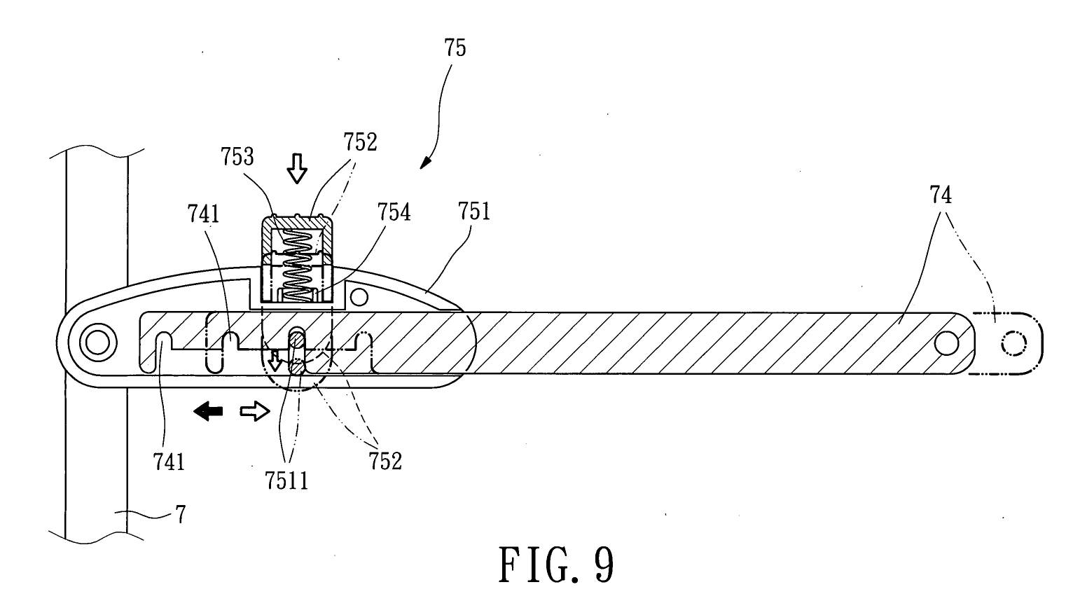

FIGS. 6˜9 show an alternate form of the present invention. According to this embodiment, two links 74 are respectively coupled between the handlebars 3 and the front extension bars 7 (see FIGS. 6 and 7), and two control devices 75 are respectively provided between the front extension bars 7 and the links 74 for operation by the user to control the biasing angle of the front extension bars 7 relative to the front-leg tubes 1 (see FIGS. 8 and 9). Each control device 75 comprises two symmetrical shells 751 fastened together and pivotally coupled to one front extension bar 7, a control button 752 vertically movably coupled to the shells 751 by a transversely extending pivot pin 7511, and a spring member 753 supported between a seat 754 at the shells 751 and an inside wall of the control button 752 to impart an upward pressure to the control button 752. The link 74 is axially movably inserted into the respective control device 75 between the control button 752 and the pivot pin 7511, having a plurality of longitudinally spaced bottom locating notches 741 for engagement with the pivot pin 7511 selectively. Normally, the spring member 753 supports the control button 752 in such a position that the pivot pin 7511 is maintained in engagement with one bottom locating notch 741 of the link 74. When the user pressed the control button 752 against the spring member 753, the pivot pin 7511 is lowered with the control button 752 and disengaged from the bottom locating notches 741 of the link 74, allowing the user to move front extension bar 7 relative to the link 74.

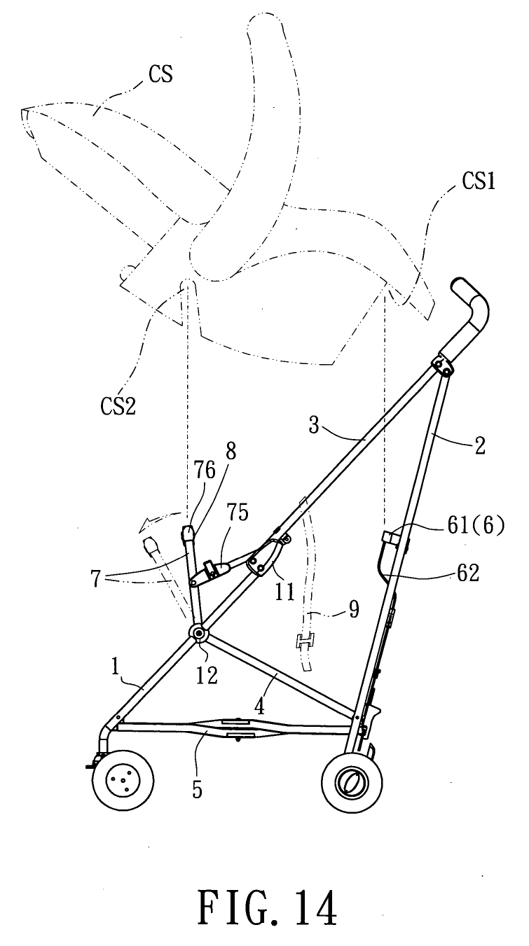

Referring to FIG. 14, when loading an infant carrier CS, the rear mounting portion CS1 of the infant carrier CS is attached to the links 61 of the folding frame 6, and then the front extension bars 7 are adjusted to a suitable angle subject to the size of the infant carrier CS, for enabling the front mounting portion CS2 to be forced into engagement with the front cross bar 8. After loading of the infant carrier CS, fasten up the safety belt, referenced by 9 to secure the infant carrier CS in position.

A prototype of baby stroller has been constructed with the features of FIGS. 1˜14. The baby stroller functions smoothly to provide all of the features discussed earlier.

Although particular embodiments of the invention have been described in detail for purposes of illustration, various modifications and enhancements may be made without departing from the spirit and scope of the invention.

What the invention claimed is:

1. A frame structure for baby stroller comprising:
two front-leg tubes, said front-leg tubes each having a first connector and a second connector;
two rear-leg tubes;
two handlebars respectively pivotally connected to the first connectors of said front-leg tubes;
two bottom tubes respectively pivotally coupled between the second connectors of said front-leg tubes and said rear-leg tubes;
wherein two front extension bars are respectively pivoted to the second connectors of said two front-leg tubes, each said front extension bar comprising a front rod member, a rear rod member pivoted to the second connector of one said front-leg tube, and a joint coupled between said front rod member and said rear rod member for allowing said front rod member to be turned relative to said rear rod member and locked at the desired angle; two quick-release locks are respectively applied on the front rod members of said front extension bars to hold a foldable front cross bar between the front rod members of said front extension bars for allowing movement of said foldable front cross bar along said front extension bars when unlocked said quick-release locks.

2. The frame structure for baby stroller as claimed in claim 1, wherein the joint of each said front extension rod comprises two holder members respectively fastened to the front rod member and rear rod member of the respective front extension bar, each said holder member having a toothed engagement portion, a toothed block movable between said holder members and engageable with the toothed engagement portions of said holder members, a spring member mounted in the holder member at the rear rod member of the respective front extension rod and stopped between the respective holder member and said toothed block and adapted to hold said toothed block in engagement with the toothed engagement portions of said two holder members to lock said holder members, and a control button applied on the holder member at the front rod member of the respective front extension bar for pressing by the user to push said toothed block backward against said spring member and to further disengage said toothed block from the toothed engagement portion of the holder member at the front rod member of the respective front extension bar.

3. The frame structure for baby stroller as claimed in claim 1, wherein the front rod member of each said front extension bar has a plurality of longitudinally spaced locating hole; each said quick-release lock comprises a base block coupled to one end of said foldable front cross bar and axially slidably sleeved onto the front rod member of one said front extension bar, a locking member mounted in said base block, said locking member having a locating pin selectively insertable in one of the longitudinally spaced locating holes at the front rod member of one said front extension bar, two spring members stopped between said base block and said locking member to hold said locking member in such a position where said locating pin is engaged into one of the longitudinally spaced locating holes at the front rod member of one said front extension bar, and a control button coupled to said locking member for pressing by the user to disengage said locking member from said longitudinally spaced locating holes.

4. The frame structure for baby stroller as claimed in claim 1, further comprising two links pivotally coupled together in a crossed manner and diagonally coupled between said front-leg tubes and said rear-leg tubes, and a folding frame coupled between said two rear-leg tubes.

5. The frame structure for baby stroller as claimed in claim 4, wherein said folding frame comprises two pairs of links respectively pivotally connected in series and respectively pivotally coupled between said rear-leg tubes at different elevations, an actuating rod pivotally coupled with top and bottom ends thereof to the pivoted point between the two links of each of the two pairs of the links of said folding frame, two drag bars respectively pivotally coupled between a middle part of said actuating rod and said rear-leg tubes, two stop bars pivotally connected in series between said rear-leg tubes below the connection point between said drag bars and said actuating rod but above the connection points between said drag bars and said rear-leg tubes, and a spring member connected between one said stop bar and one said rear-leg tube to impart a downward pressure to said stop bars.

6. A frame structure for baby stroller comprising:
two front-leg tubes, said front.-leg tubes each having a first connector and a second connector;
two rear-leg tubes;
two handlebars respectively pivotally connected to the first connectors of said front-leg tubes;
two bottom tubes respectively pivotally coupled between the second connectors of said front-leg tubes and said rear-leg tubes;
wherein two front extension bars are respectively pivoted to the second connectors of said two front-leg tubes; two links are provided between said front-leg tubes and said front extension rods, said links each having a first end respectively pivoted to said front-leg tubes and a second end; two control devices are respectively coupled between said links and said front extension bars and controllable between a locking position to lock said links to said front extension bars and an unlocking position for enabling said front extension bars to be moved relative to said links and turned relative to said front-leg tubes; two quick-release locks are respectively applied on the front rod members of said front extension bars to hold a foldable front cross bar between said front extension bars for allowing movement of said foldable front cross bar along said front extension bars when unlocked said quick-release locks.

7. The frame structure for baby stroller as claimed in claim 6, wherein each said front extension bar has a plurality of longitudinally spaced locating hole; each said quick-release lock comprises a base block coupled to one end of said foldable front cross bar and axially slidably sleeved onto one said front extension bar, a locking member mounted in said base block, said locking member having a locating pin selectively insertable in one of the longitudinally spaced locating holes of one said front extension bar, two spring members stopped between said base block and said locking member to hold said locking member in such a position where said locating pin is engaged into one of the longitudinally spaced locating holes at one said front extension bar, and a control button coupled to said locking member for pressing by the user to disengage said locking member from said longitudinally spaced locating holes.

8. The frame structure for baby stroller as claimed in claim 6, further comprising two links pivotally coupled together in a crossed manner and diagonally coupled between said front-leg tubes and said rear-leg tubes, and a folding frame coupled between said two rear-leg tubes.

9. The frame structure for baby stroller as claimed in claim 8, wherein said folding frame comprises two pairs of links respectively pivotally connected in series and respectively pivotally coupled between said rear-leg tubes at different elevations, an actuating rod pivotally coupled with top and bottom ends thereof to the pivoted point between the two links of each of the two pairs of the links of said folding frame, two drag bars respectively pivotally coupled between a middle part of said actuating rod and said rear-leg tubes, two stop bars pivotally connected in series between said rear-leg tubes below the connection point between said drag bars and said actuating rod but above the connection points between said drag bars and said rear-leg tubes, and a spring member connected between one said stop bar and one said rear-leg tube to impart a downward pressure to said stop bars.
